(19) United States
(12) Patent Application Publication
(10) Pub. No.: US 2013/0246031 A1
(43) Pub. Date: Sep. 19, 2013

(54) Constructing Geologic Models From Geologic Concepts

(71) Applicants: XiaoHui Wu, Sugar Land, TX (US); Christine Iannello Bachtel, Houston, TX (US); Roger B. Bloch, Calgary (CA); Larisa Branets, Conroe, TX (US); Xiuli Gai, Katy, TX (US); Subhash Kalla, Houston, TX (US); Hongmei Li, Sugar land, TX (US); Rossen R. Parashkevov, Houston, TX (US); Gregory D. Robertson, Houston, TX (US)

(72) Inventors: XiaoHui Wu, Sugar Land, TX (US); Christine Iannello Bachtel, Houston, TX (US); Roger B. Bloch, Calgary (CA); Larisa Branets, Conroe, TX (US); Xiuli Gai, Katy, TX (US); Subhash Kalla, Houston, TX (US); Hongmei Li, Sugar land, TX (US); Rossen R. Parashkevov, Houston, TX (US); Gregory D. Robertson, Houston, TX (US)

(21) Appl. No.: 13/884,592

(22) PCT Filed: Aug. 29, 2011
(86) PCT No.: PCT/US11/49562

§ 371 Date: May 9, 2013

Related U.S. Application Data
(60) Provisional application No. 61/421,038, filed on Dec. 8, 2010.

(51) Int. Cl. G06F 17/50

(52) U.S. Cl. CPC G06F 17/5009
USPC 703/10

(57) ABSTRACT

Method for constructing a geologic model of a subsurface region. A concept region and a geologic concept is selected (300). A design region is created corresponding to the concept region (310). A conceptual model is generated compatible to data in the design legion (320). The conceptual model is mapped from the design legion concept region (330). The conceptual interfaces and region properties may be adjusted to match data in the concept region (340).

This application claims the benefit of U.S. Provisional Patent Application 61/421,038 filed Dec. 8, 2010 entitled CONSTRUCTING GEOLOGIC MODELS FROM GEOLOGIC CONCEPTS, the entirety of which is incorporated by reference herein.

### FIELD OF THE INVENTION

The invention relates generally to the field of geologic modeling for hydrocarbon exploration or production and, more particularly to generating the geologic model from a geologic concept expressed in functional terms, or from a library of generic geologic concepts.

### BACKGROUND

A geologic model is a computer-based 3-dimensional representation of a region beneath the earth's surface. Such models are typically used to model a petroleum reservoir or a depositional basin. After formation, the geologic model can be used for many purposes. A common use for the geologic model is as an input to reservoir simulations, which are used to predict hydrocarbon production from a petroleum reservoir over time.

Because technologies for detecting subsurface structures and rock properties either have limited resolution (e.g., seismic imaging) or limited coverage (e.g., well logging), it is usually necessary for a geologic model to incorporate interpreted or conceived geologic descriptions that may have a significant effect on the movement of fluids in the reservoir. These descriptions will be called geologic concepts herein.

The conceptual descriptions of geology are often uncertain. In practice, it is important to conduct uncertainty analysis of different geologic scenarios, which involves multiple reservoir simulations on different geologic models with varying conceptual descriptions. Furthermore, when production history is available, it is important to adjust geologic models such that predictions based on these models match the production history. This is an inverse problem that generally has non-unique solutions. In either case, many reservoir simulations are usually required. Thus, precise and efficient modeling of geologic concepts while honoring measured data is critical to the successful application of geologic modeling.

Existing techniques for modeling geologic concepts are inadequate. Geostatistical methods rely on uniform or quasi-uniform geo-cellular grids and are limited to model stationary stochastic processes. Consequently, these methods are inefficient to represent geologic features at very different scales and are ill adapted to non-stationary distributions of geologic elements commonly observed in the subsurface. Also, these methods are limited in their ability to precisely represent the descriptive elements that are in minor abundance but have great impact on fluid flow (e.g., thin shale layers). Object-based methods help resolve some of these limitations; however, the lack of control over the shape and placement of the objects makes it difficult to condition the resulting model of descriptive elements to data collected from the reservoir. Recently, a stochastic surface modeling technique was proposed for deepwater depositional systems. Stacking of lobes in turbidite systems are modeled sequentially following a series of stochastic depositional events. The method is limited to modeling simple lobe geometry with explicit functional representation of the lobe thickness distribution.

The following references contain background material that may be useful to the reader:
Dubrule, O., et al., 1997, Reservoir Geology Using 3-D Modeling Tools, SPE 38659.
Landis, Lester H. and Peter N. Glenton, 2007, Reservoir Model Building Methods, published U.S. patent application 2007/0061117.
Murphy, William F. et al., 2000c, Apparatus for Creating, Testing, and Modifying Geological Subsurface Models, U.S. Pat. No. 6,070,125.
Pyrcz, M. J., et al., 2005, Stochastic Surface-Based Modeling of Turbidite Lobes, AAAPG Bulletin, V. 89, No. 2, pp. 177-191.
Scaglioni, P. et al., 2006, Implicit Net-to-Gross in the Petrophysical Characterization of Thin-Layered Reservoirs, Petroleum Geoscience, V. 12, pp. 325-333.
Sech, R., 2007, Quantifying the Impact of Geological Heterogeneity on Gas Recovery and Water Cresting, with Application to the Columbus Basin Gas Fields, Offshore Trinidad, PhD Dissertation, Imperial College London.
Wen, w., et al., 1998, Three-Dimensional Simulation of Small-Scale Heterogeneity in Tidal Deposits—a Process-Based Stochastic Simulation Method. In: Buccianti, A. et al., (eds.), Proceedings of the 4th Annual Conference of the International Association of Mathematical Geology (IAMG), Naples, pp. 129-134.
Wentland, Robert and Peter Whitehead, 2007a, Pattern Recognition Template Construction Applied to Oil Exploration and Production, U.S. Pat. No. 7,162,463.
Wentland, Robert and Peter Whitehead, 2007b, Pattern Recognition Template Application Applied to Oil Exploration and Production, U.S. Pat. No. 7,188,092.
X. Zhang, M. J. Pyrcz, and C. V. Deutsch, Stochastic surface modeling of deepwater depositional systems for improved reservoir models, Journal Petroleum Science and Engineering, 68, 118-34, 2009.

Other related material may be found in U.S. Pat. Nos. 5,905,657; 6,035,255; 6,044,328; and 6,191,787; and U.S. patent application 2009/0,312,995 A1.

### SUMMARY

In one embodiment, the invention is a computer implemented method for constructing a geologic model of a subsurface volume comprising:

(a) selecting a geological structural framework for the subsurface volume; and
(b) using a computer to generate values of one or more physical properties for one or more regions within the geological structural framework using a conceptual model based on geologic concepts, said conceptual model comprising the one or more concept regions with one or more interfaces, wherein the interfaces are expressed in implicit functional form and the concept regions are expressed in explicit or implicit functional forms.

### BRIEF DESCRIPTION OF THE DRAWINGS

The present invention and its advantages will be better understood by referring to the following detailed description and the attached drawings in which:

FIG. 1 is a schematic diagram illustrating a procedure for applying GCMs to faulted regions in one embodiment of the present invention;

FIG. 2 is a flowchart showing basic steps in a modeling procedure using GCMs according to the present invention;

FIG. 3 is a flowchart showing basic steps in a procedure for designing geologic GCMs according to the present invention and storing them for future use;

FIG. 4 shows an example of implicit modeling of conceptual regions as Voronoi tessellation, with the 2D diagram being formed by point skeletons, distance-based generators, and a simple selection function R;

FIGS. 5A-D show a two-dimensional example of a selection function according to the present invention;

FIG. 6A shows an example of a faulted concept region, and FIG. 6B shows the same region unfaulted;

FIG. 7 illustrates partitioning a faulted block into simple blocks by extending fault surfaces;

FIG. 8 shows an example where the block from FIG. 8 is embedded in a regular Cartesian grid, and where cells and nodes in fault areas are duplicated;

FIG. 9 shows another example in which cells/nodes need to be duplicated on opposite sides of a fault;

FIGS. 10A-B illustrate the first step of forming a compatible realization when conditioning a geological model to well data;

FIGS. 11A-B illustrate adjusting the generator functions for generators parameterized with skeletons changing their parameterization;

FIG. 12 illustrates a two-step process for adjusting generator functions for conditioning to well tops, where first global optimization is applied by adjusting the parameters of the generators, then the generators are enriched by adding local functions with additional parameters;

FIGS. 13A-B illustrate an example of adding a local feature to an implicit surface for conditioning the conceptual model to well data;

FIG. 14 shows a hierarchical interpretation of a deepwater channel-lobe system; and

FIGS. 15A-D show an automatic nested mapping of a generic concept model into the concept region.

Due to patent law restrictions, some of the drawings are black-and-white reproductions of colored originals.

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims. Persons skilled in the technical field will readily recognize that in practical applications of the present inventive method, at least all the modeling computations must be performed on a suitably programmed computer.

### DETAILED DESCRIPTION

This invention is directed to systems and methods that allow for rapidly constructing and updating geologic models with descriptive geologic concepts. This invention is related to the method of geologic modeling using pre-built and re-usable generic concept models (“GCMs”) that include elements and properties that may affect the movement of fluids in the subsurface region that is disclosed in PCT International Patent Application Publication No. WO 2010/056427 by Calvert et al., entitled “Forming a Model of a Subsurface Region,” which is incorporated herein for all purposes. More specifically, the present invention provides systems and methods for modeling geologic concepts using functional representations. Methods for creating GCMs and applying them in a geologic model are described. The functional representation of geologic concepts can be used to construct geologic models with or without pre-built GCMs. Efficient methods to condition geologic models to measured subsurface data are also disclosed.

One embodiment in accordance with the presently disclosed technique is a method for creating, storing, and using a generic concept model (“GCM”) for the purpose of modeling subsurface geology. A GCM encapsulates rules and parameters that control the creation of geologic models based on a geologic concept. Explicit and implicit functional representations of geometry and 2D/3D property distribution may be used to define a GCM. The functions may be parameterized and can be adjusted to generate different realizations of the GCM. The GCM may be modeled in a continuous design space. A mapping from physical (possibly faulted) space to the design space may be used to sample shape and/or properties of GCM in the physical (possibly faulted) space for visualization and quality control, and further applications of the model, e.g. in numerical simulations. Different sampling strategy may be used based on the purpose of sampling.

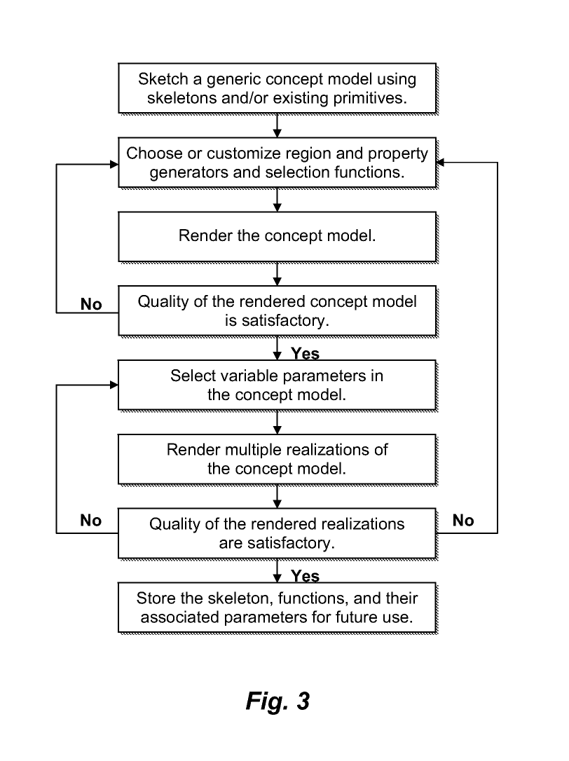

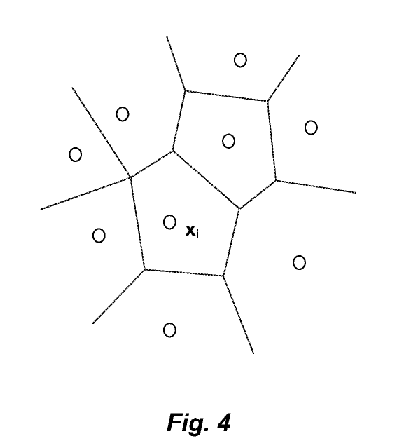

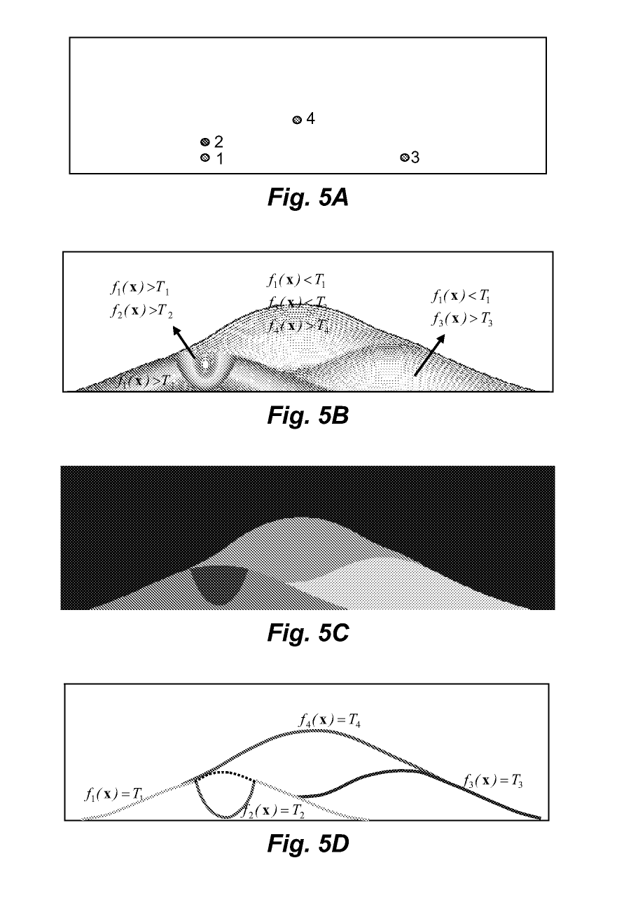

One embodiment of the present techniques is a method of building and storing GCMs. Appropriate functional representations can be determined through an iterative process such as is indicated by the basic steps shown in the flowchart of FIG. 3. The process may utilize a graphical user interface or a scripting language to define and/or customize skeletons, functions, adjustable parameters, rules, and a visualization environment to visualize the functional representations of the concept on a display device such as computer monitor.

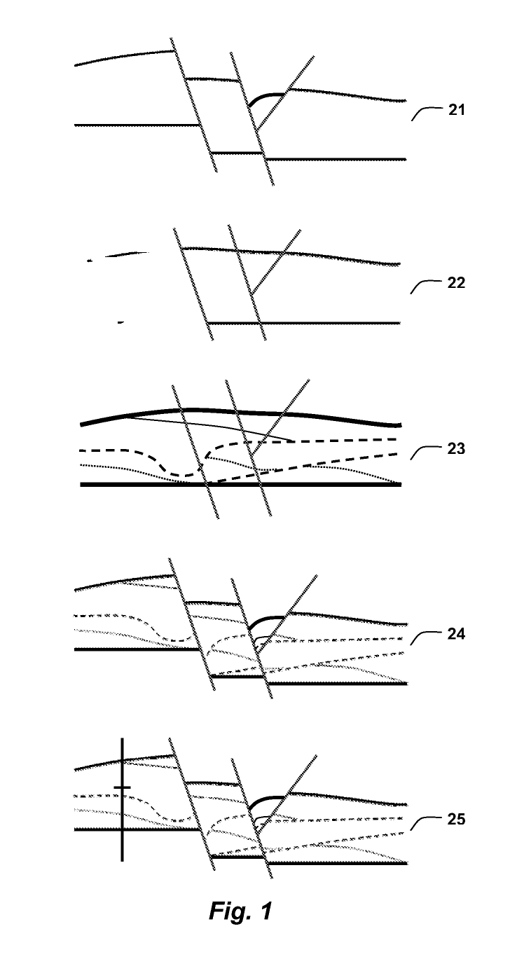

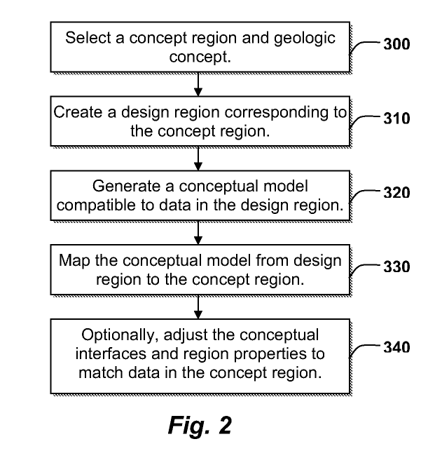

One embodiment in accordance with the present techniques is a method of forming a geologic model of a subsurface region, illustrated for example by the schematic diagram of FIG. 1 and the flowchart of FIG. 2. The subsurface region and associated measured data are transformed into a design region. The geologic concept associated with the subsurface region is modeled and optionally conditioned to data in the design region. The model is then transformed back to the subsurface region. Depending on the accuracy of the transformation, the geologic concept may be adjusted in the subsurface region to better honor the measured data.

One embodiment in accordance with the present technique is a method of forming a continuous design region from a faulted subsurface region. The subsurface region may be identified from an input structural framework. The subsurface region may consist of a plurality of blocks separated by horizon and fault surfaces. The horizons and faults bounding each block may be restored to unfaulted positions and form a continuous design region via automatic or manual methods. A displacement field that maps any point of the subsurface region to a point in the design region may be calculated by solving linear elasticity equations and its variations with displacement boundary conditions on the restored horizons and faults. The solution may be obtained on the grid nodes of a regular grid covering each block using immersed boundary methods. The displacement vectors on the grid nodes may be interpolated to give the desired mapping. Note for future reference in reading further in this document that the use of a cellular grid being discussed here is not for the purpose of expressing the geologic concepts used to develop a conceptual model.

Another embodiment in accordance with the present techniques is a method of modeling geologic concepts in a continuous region with or without a geo-cellular grid. A geologic concept may be represented by a set of conceptual surfaces and conceptual regions between the surfaces. The conceptual surfaces may be represented using functions based on geometric skeletons consisting of reference surfaces, lines, and/or points. The conceptual regions are bounded by the conceptual surfaces as well as region boundaries. Properties within a conceptual region and/or on conceptual surface may be represented using functions parameterized relative to reference surfaces, lines, and/or points. These reference objects may be different from the skeletons used for modeling conceptual surfaces. The properties may also be represented using functions parameterized relative to other properties. Neither the surface nor property representations require a geo-cellular grid.

Another embodiment in accordance with the present techniques is a method of conditioning geologic concepts to measured data. Conditioning can be done in a hierarchical manner where children elements are conditioned to the parent (either conceptual or interpreted). For one level of hierarchy, first the conceptual surfaces may be conditioned to well picks by adjusting the parameters of implicit or explicit functions that represent the surfaces. Then the parameters of the functions representing the properties in the conceptual regions may be adjusted so that properties honor trends observed from seismic data or estimated values measured at wells.

Some definitions are given next, followed by a more detailed explanation of the embodiments described more briefly above.

An interface is a surface that separate regions having contrasting flow properties, and/or behave as a barrier or conduit to flow. An explicit interface is an interface whose geometry can be observed in or interpreted from data. Horizons and faults are explicit interfaces. A conceptual interface is an interface whose existence is largely based on a geologic concept with little direct support from data; its geometry is highly uncertain except at sparse locations in the region of interest. If an interface, explicit or conceptual, represents a thin layer of rock that either blocks or conducts flow, the interface is called a material interface; otherwise, it is called a contact interface.

A region is a volume within the geologic model, bounded by one or more interfaces. A region may be assigned spatially varying rock and fluid properties. A region may be hierarchical, i.e., it may contain other regions and interfaces. Typically, an interface is part of the boundary of a region. However, an interface can be free if it does not bound any region. A conceptual region is a region that is bounded by at least one conceptual interface. Depending upon context, a region may instead refer to a volume in the actual subsurface earth.

A concept region is the union of a set of regions where one group of related geologic concepts is applied. For example, a concept region can consist of one region, or it can consist of multiple regions bound by two discontinuous horizons and faults intersecting them.

A concept model is a three dimensional, computer-based representation of a group of geologic concepts and their relationships for a specific geologic setting in a concept region. It includes at least one region, interfaces, and properties associated with the interfaces and regions.

A generic concept model (GCM) is a quantitative characterization of a group of geologic concepts and their relationships for a specific geologic setting. It includes at least one region, interfaces, and rules or procedures for realizing, on a computer, the regions, interfaces, and their properties that depend on a set of parameters. Thus, a concept model can be created by setting parameters of a GCM to specific values and applying the GCM procedures to generate a computer realization.

A design region is a more continuous region for modeling geologic concepts, especially when concept model construction is involved. In geologic modeling, a design region can correspond to a faulted concept region through a coordinate transformation or mapping between the two regions.

A geo-cellular grid is a three-dimensional grid that covers the area of interest of a reservoir and is commonly used in geologic models in represent geologic data and concepts as piecewise constant properties in the grid cells.

One or more embodiments of the present techniques form a geologic model for a region of interest. The region of interest may comprise a subsurface region, such as a petroleum reservoir or a depositional basin, or any other subsurface area. The geologic model of the region of interest can be used for many purposes, for example, such a geologic model may be used as an input to a reservoir simulation program for predicting hydrocarbon production.

In the following, it is assumed that a geologic structural framework is given, which framework is comprised of typically several, but at least one, (faulted) concept regions, each region being associated with geologic concepts based on geologic interpretations of the subsurface data. The present invention provides techniques for creating a concept model within each concept region with or without the use of a geo-cellular grid. This invention uses functional representation of interfaces, regions, and properties. The interfaces are expressed in implicit functional form, and the regions are expressed in explicit or implicit functional form, neither of which require use of a geo-cellular grid in order to express them. The physical properties being modeled are also expressed in explicit or implicit functional form. The functional representations can quantitatively characterize geologic GCMs in a compact manner and can be stored in a GCM library for future reuse. Furthermore, this invention uses the functional representations and a hierarchical approach to efficiently condition the concept model to seismic and well data. If a conceptual model is based on geologic concepts that are expressed only numerically, i.e. by numbers assigned to cells in a geo-cellular grid, then that falls outside the present invention. The option of not using geo-cellular grids is a fundamental difference between this invention and existing modeling methods. For the purpose of this document, the term “implicit functional form” means that the point set that forms an interface or region is defined implicitly through (differential or functional) operator equations or inequalities, where an operator maps values of one or more possibly over-lapping spatial functions to a bounded set of scalar or vector values. In contrast, the term “explicit functional form” means that a surface can be written as an analytical formula mapping two independent parameters to 3D points on the surface, and that a volume and a volumetric property can be written as an analytical formula mapping three independent parameters to 3D points in the volume and one or more values at the 3D points, respectively.

The modeling is performed following the procedure outlined in the flowchart of FIG. 2. At step 300, a concept region and a geologic concept are selected. This is illustrated by diagram 21 of FIG. 1. At step 310, the concept region and its associated data are mapped to a design region. See diagram 22 of FIG. 1. The mapping can be identity. Data may include well data and seismic attributes.

At step 320, a conceptual model is created in the design region to represent the geologic concepts associated with that region. See diagram 23 of FIG. 1. A GCM corresponding to the concepts may be selected from a GCM library and applied to the region to form a conceptual model. Alternatively, methods used for creating GCMs can be applied directly in the region. The conceptual model optionally may be adjusted so that the interfaces and region properties are consistent with data. Consistency criteria may be defined by the user to suit the specific modeling purpose. In general, interfaces should pass through wells at locations they are observed, and region properties should have trends matching the trends indicated by seismic data and have values matching the estimates derived from direct measurements along well tracks. The adjustment involves modifying GCM parameters either manually or automatically until consistency is reached. This adjustment to measured data is sometimes called “conditioning.”

At step 330, the conceptual model is mapped back into the concept region. See diagram 24 of FIG. 1. It may happen that the conceptual models are distorted slightly during the mapping process. In this case, additional adjustments to the conceptual model can be made to match data in the concept region. (Step 340 of FIG. 2, and diagram 25 of FIG. 1) It is noted that the mapping will typically use a grid, but this will not be a geo-cellular grid.

Next, further details of the techniques mentioned above are provided.

Create Geologic GCMs: Representation

A GCM is a quantitative characterization of a group of geologic concepts that may be modeled as a hierarchical volumetric element in a continuous region with or without a geo-cellular grid. A geologic concept in the GCM is represented by a set of conceptual interfaces and conceptual regions between the interfaces. The interfaces are represented using functions based on geometric skeletons consisting of reference surfaces, lines, and/or points. The conceptual regions are bounded by interfaces as well as region boundaries such as interpreted top or bottom horizons. Properties within a conceptual region and/or on interfaces are represented using functions parameterized relative to reference surfaces, lines, and/or points. These reference objects may be different from the skeletons used for modeling interfaces. The properties may also be represented using functions parameterized relative to other properties. Neither the interface nor property representations require a geo-cellular grid.

Given a geologic setting, the design region is divided into conceptual regions bounded by conceptual and/or explicit interfaces. Usually, these regions correspond to depositional and erosional events as depicted in a geologic theory for that specific setting. A generating function or generator is defined for each conceptual region. The function is nothing but a function that maps every point x in the design region D into a scalar value. The generator is parameterized such that varying the parameters gives a family of mappings. A parameter is typically a coefficient of the function that does not depend on the coordinates of the point x. A generator may also contain constants whose values are fixed and are independent of the parameters and x. Parameters can change together in correlated ways; for this reason, they are sometimes referred to as the skeleton of the generator.

Once the generators are defined, each point in the design region is mapped to a conceptual region through a selection function. More precisely, let there be N conceptual regions in a design region D with generating functions ƒᵢ(x;pᵢ,cᵢ) for xεD and i=1, . . . , N, where pᵢ and cᵢ are vectors of parameters and constants that are associated with ƒᵢ. With the generators, a selection function R can be defined to map any point in the design region to a conceptual region. The mapping typically depends on the generator values at x. In general, the selection function has the form of R(x)=k, where k is an integer in the range of [1, N].

Once every point in a design region is marked based on R, the conceptual interfaces are implicitly defined by the boundaries between the conceptual regions. In practice, the geometry of conceptual interfaces needs to be represented explicitly in order to generate simulation grid on the reservoir model or assigning properties to material interfaces. Methods for tracing iso-surfaces (e.g., the marching cube method) can be used to extract the explicit conceptual surfaces from implicit ones. Some choices of generators and selection rules can lead to more efficient conversion, e.g., generators defined with the help of displacement vector fields with simple selection rule can provide explicit surface representation through direct use of the displacement fields.

The generators can be defined analytically or numerically. Sometimes, they are obtained by solving partial differential equations (“PDEs”). In practice, it is preferred that the generators and selection function can be evaluated rapidly at each point in the design region to allow efficient sampling of the GCM. Thus, when possible, simple analytical functions are preferred. Alternatively, a generator can represent a distance to the design region boundaries computed based on a field of 3D displacement vectors. Such a displacement vector field can be defined as a solution to a partial differential equation (“PDE”) inside the design region which uses skeleton geometries as boundary conditions.

A conceptual region can be treated as a design region and the above procedure can be repeated to form a hierarchy of design regions at decreasing scales. The hierarchical modeling can be adaptive—only those conceptual regions that require more detailed modeling need to be enriched with conceptual regions and interfaces at smaller scales. In fact, hierarchical modeling is preferable because the generators can be evaluated more efficiently. For example, the generators for smaller regions can be evaluated only within the enclosing region instead of entire design region. Moreover, generators enclosed in different regions can be processed in parallel.

Reservoir rock properties are modeled within each conceptual region. Since abrupt changes in reservoir properties are captured by the interfaces, the properties within a conceptual region are relatively smooth and hence it is advantageous to model the properties using smoothly varying functions that can be controlled by a few parameters. Traditional geo-cellular modeling technique can still be used, provided that a suitable geo-cellular grid is generated within each conceptual region. However, this invention includes a functional approach that works without generating geo-cellular grids.

Distribution of a scalar property, such as porosity, can be obtained through a scalar generation function (or generator). In many geologic settings, property trends can be identified with respect to bounding surfaces of the region. For this purpose, the explicit and conceptual interfaces can be used as reference surfaces to model property trends.

Generators can also be used to model tensor properties such as permeability. Each component of the permeability tensor (representing permeability in x, y and z direction) can associate with a separate generator function. Another approach is to specify the principal components and principal axes of the permeability tensor. With the latter approach, one can easily ensure that the resulting tensor is symmetric and positive semi-definite everywhere in a region. In many geologic scenarios, the principal directions of the permeability field in a region depend strongly on the bounding interfaces.

Examples of a GCM Representation

One type of generator is a distance-based function from a given skeleton, which can be for example a set of points, lines, polylines, curves, polygon soup or surface (J. Bloomenthal., Introduction to Implicit Surfaces, Morgan Kaufmann Series in Computer Graphics and Geometric Modeling, Morgan Kaufman Publishers, Inc., San Francisco, 1997). FIG. 4 shows an example of conceptual regions defined by distance-based generators and a simple selection function. In the figure, the skeletons are a set of points xᵢ (i=1, . . . , N). The generators are given by ƒᵢ(x)=∥x−xᵢ∥, i.e., the distance from any point x to xᵢ. The selection function is

R(x)=k, such that ƒₖ(x)≦ƒᵢ(x) for i=1, . . . ,N.

The above generators and selection function produce a Voronoi tessellation of a design region, with N Voronoi cells, each cell surrounding a skeletal point xᵢ. It should be noted that the skeletal point xᵢ is a parameter of ƒᵢ(x). This type of generator can be extended to skeletons made up of point sets. Let S be a set of points. A generator may be defined as the distance from S, i.e.,

$$f ( x ) = d ( x , S ) = {min}_{y ∈ S} ‖ x - y ‖ .$$

An extension of a distance function is a distance-based function:

$$f ( x ) = g ( {min}_{y ∈ S} ‖ x - y ‖ ) ,$$

where g is a function used to control the shape of the conceptual regions (note that g may contain other parameters than S). It should be noted that the definition of the distance between x and y is not limited to Euclidean distance. Other distances can also be used. One example is to use the Euclidean distance in a transformed space:

∥x−y∥=∥T(x)−T(y)∥_{E},

where T is a mapping that maps a point in the physical space into a transformed space and ∥•∥_{E} is the Euclidean distance in the transformed space. A linear transformation that stretches the z-coordinate of a point is often useful in modeling reservoir geology with a high aspect ratio (i.e., the ratio between characteristic lengths in lateral direction and the vertical direction).

Another example of a generator is based on convolution of a kernel function K with the point set, i.e.,

$$f ( x ) = {\int }_{y ∈ S} K ( x , y ) d S$$

Similar to the conceptual region generators, property generators may be distance-based functions or convolution functions against certain skeletons.

To reduce the number of parameters of a generator, the point set is usually characterized by interpolations of a few control points. For example, a curvilinear point set or curvilinear lines can be represented by splines, which are smooth interpolations of a few control points. These points provide controls on correlated variation of the point set. Thus, a generator based on a curvilinear line is said to be parameterized by the control points on the line. Similarly, a point set may be represented by spline surfaces, radial basis functions or other sparse representations of lines or surfaces through controls points.

In an example of property generator, to model a “coarsening upward” trend in a region, the “bottom” surface of a region can first be identified. This can be done by determining the age of the neighboring region, which can be assigned during the construction of the conceptual regions. The “bottom” surface should separate a region from its older neighbors. A reference plane can be created to establish a coordinate system (or reference space) associated with the surface. The generator can be a composite function of the following form

p(x)=p′(T⁻¹(x)), p′(ξ)=h(g(ξ,η),ζ),

where T is the mapping from reference space point ξ to model space point x, g is a two-dimensional function determining the property distribution on the surface. In practice, the surface can be approximated by using splines or other piecewise smooth surface patches so that T and its inverse can be evaluated efficiently. A simple but commonly used example of T is given by: x=ξ, y=η, z=ζ−zₛ(ξ,η); where zₛ is the explicit function representing the bottom surface.

The selection function can be defined in many different ways. As shown above, one way is based on comparison of generator values at the same point. FIGS. 5A-D show a two-dimensional example of a selection function based on more complex rules. The method can be extended easily to three dimensions. FIG. 5A shows four skeleton points in the order of geologic events that are used to define four generators using distance-based method. Points 1, 3 and 4 represent depositional regions; point 2 represents an erosional region. First, we define

Fᵢ(x)=C₁ᵢexp(−C₂ᵢ∥x−xᵢ∥²+C₃ᵢ(y−yᵢ)),

with C_{1I} and C₂ᵢ being constants. The generator functions are constructed from Fᵢ:

ƒ₁=F₁, ƒ₂=F₂, ƒ₃=ƒ₁+F₃, and ƒ₄=ƒ₃+F₄.

The selection function is defined as the following:

$$R ( x ) = \{ \begin{matrix}1 & if {f}_{1} ( x ) > {T}_{1} ; \\ 2 & if {f}_{1} ( x ) > {T}_{1} and {f}_{2} ( x ) > {T}_{2} ; \\ 3 & if {f}_{1} ( x ) < {T}_{1} and {f}_{3} ( x ) > {T}_{3} ; \\ 4 & if {f}_{1} ( x ) < {T}_{1} and {f}_{3} ( x ) < {T}_{3} and {f}_{4} ( x ) > {T}_{4} .\end{matrix}$$

Here, Tᵢ (i=1, 2, 3, 4) are constant scalar values that also control the shape and size of the conceptual regions. Note that the conceptual region 2 is an erosional feature embedded in the conceptual region 1. Generalization of the selection function to an arbitrary number of regions is straightforward. FIG. 5B shows the contour lines of the generators in their respective conceptual regions. The solid colors in FIG. 5C show the implicitly defined conceptual regions, partitioned based on generators ƒ₁, ƒ₂, ƒ₃ and ƒ₄. The selection function allows for modeling both depositional and erosional regions. FIG. 5D shows the boundaries of the conceptual regions as defined by contours of the generators.

Create Geologic GCMs: Method of Building and Storing GCMs

A GCM encapsulates rules and parameters that control the creation of geologic models based on a geologic concept. The GCM may be defined by the functions and their adjustable parameters that represent the surfaces and conceptual regions defined by the geologic concept. Appropriate functional representations can be determined through an iterative process such as the one outlined in the self-explanatory flowchart of FIG. 3. The process may utilize a graphical user interface or a scripting language to define and/or customize skeletons, functions, adjustable parameters, and a visualization environment to visualize the functional representations of the concept on a display device such as computer monitor. Functions, parameters and rules that quantitatively characterize GCMs can be stored in a GCM library for future reuse.

Create Design Region

The reason for creating a design region is twofold. First, geologic concepts are best described in a continuous region. Secondly, a continuous region enables efficient and flexible conceptual modeling using functional representations (see above). To do so, the design region needs to be constructed such that discontinuities caused by fault juxtaposition as well as different types of truncations are properly handled. Existing geologic modeling techniques can be used to convert a faulted geologic model into a continuous “datum IJK space” (as in popular geologic modeling software) or “uvt space” (U.S. Pat. No. 7,711,532) so that geologic property modeling can be applied there. These methods generate global transformation of the geologic model, but they can also be applied per concept region.

The above-described methods have some shortcomings when applied to the present invention's modeling approach. First, the datum IJK space in commercial packages requires a structured corner point grid be generated on the geologic model. For irregular shaped concept regions, forcing an IJK structure on the grid may induce high distortion during the mapping process and lead to unrealistic models. In generating the uvt space, a 3D unstructured grid is generated to calculate the mapping. Also, the generation of the uvt space based on the GeoChron method (J. L. Mallet, Space-time mathematical framework for sedimentary geology, Mathematical Geology 36, 1-32 (2004)) requires that the horizons are mapped into flat surfaces in the uvt space. Such a mapping may introduce large distortions when the horizons pinch out (coincide) in some area, a common phenomenon due to erosion events in the depositional process.

Below, an alternative method based on the concept of a displacement field u(x) for all x in a concept region is described. The displacement field is constructed such that discontinuities in horizons due to fault juxtaposition are removed and that distortion of the concept region is minimized. Thus, instead of being flattened, the horizons bounding a concept region are kept as close to their original geometry as possible. To do so, partial differential equations based on elliptic boundary value problems or linear elasticity problems are solved on a regular (e.g., Cartesian) grid that covers the concept region. In more detail, the procedure may be the following.

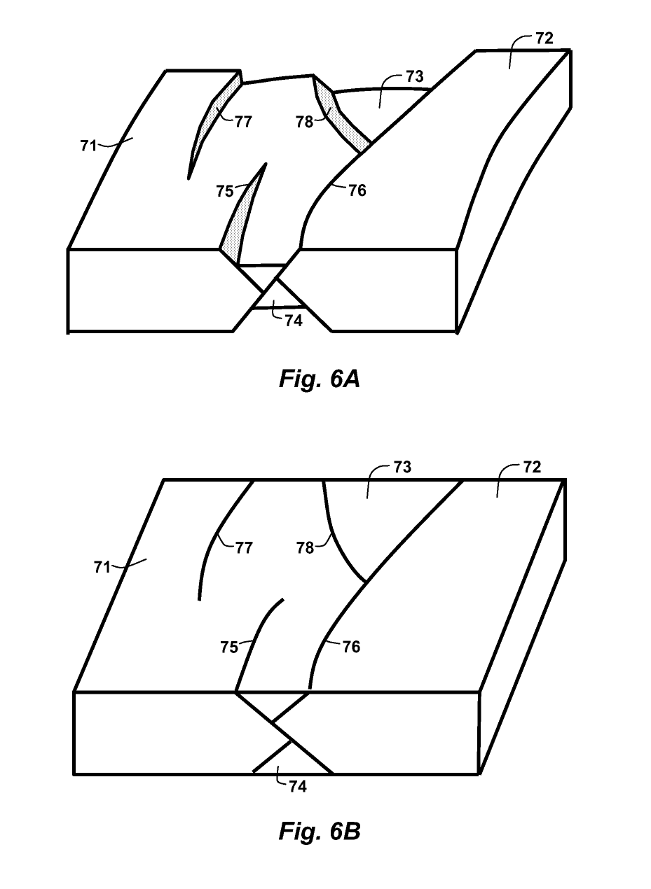

First, a faulted structural framework is provided as input and concept regions are identified. An example of a faulted concept region is shown in FIG. 6A, where a concept region is split into four separate blocks, 71, 72, 73, and 74. Blocks 72, 73, and 74 are simple blocks that contain no faults; Block 71 is a connected but faulted block, where fault 75 is faulted by fault 76. The shaded areas are exposed fault surfaces.

Next, the displacement vectors are determined along horizon-fault and fault-fault intersections. These vectors can be calculated from the up-thrown and down-thrown fault traces on each faulted horizon or fault surface. The fault traces generated by intersections of Faults 75, 77, and 78 can be seen in FIG. 6A. The fault traces are typically included in the input structural framework as part of interpretation of reservoir geology.

The displacement vectors provide boundary conditions for generating the displacement field in each block. Alternatively, these boundary conditions can be extended to horizon and fault surfaces before calculating the displacement field. Extension to fault surfaces is preferred in order to ensure that discontinuity in the displacement field near faults does not create gaps or overlaps between mapped blocks. Restoring horizons is not always necessary in practice; however, it provides better controls on the generation of the displacement field.

To restore horizons and remove fault throws, the method by Rutten and Verschuren (K. W. Rutten and M. A. J. Verschuren, “Building and unfaulting fault-horizon networks,” Geological Society, London, Special Publications 212, 39-57 (2003)) can be used. This method uses local extension of the displacement field away from the faults and is limited to relatively small displacements. A better method may be to restore the horizons by minimizing the overall deformation of the horizons. Various approximate methods can be used. One method is to model a horizon as a thin elastic plate and solve a thin plate deformation problem with displacement boundary conditions along fault traces. Since the displacement field is typically much smoother than the horizon surface, it is preferable to solve the thin plate problem on a coarse grid to speed up the solution. Discontinuous fault surfaces can be restored similarly. Restored horizons and faults are shown in FIG. 6B. Fault 76 is discontinuous after restoration. Alternative methods can be used to restore these surfaces. Sometimes, manual restoration by an experienced structural geologist is required to deal with complicated faulting.

With the displacement boundary conditions on fault traces or horizon/fault surfaces, one can generate the 3D displacement field. To reduce distortion, the displacement field is required to satisfy a linear elasticity equation:

∇·σ=f, σ=λTr(ε)I+2με, ε=½(∇u+∇u^{t}); (2)

where σ is the stress tensor, f is body force which is typically set to zero, Tr is the trace operator, λ and μ are Lame constants that are a property of the concept region which is assumed to be an elastic material, and ε is the strain tensor. The Lame constants are often expressed in terms of Young's modulus E (>0) and Poisson's ratio v (−1<v<½) as

$$λ = \frac{v E}{( 1 + v ) ( 1 - 2 v )} , μ = \frac{E}{2 ( 1 + v )} .$$

In this invention, the above equation may be solved using an immersed interface method. A regular, preferably Cartesian, grid is generated to cover each block of the concept region. If necessary, local refinement may be applied to ensure the grid cells adequately resolve the variations in the displacement vectors on the bounding surfaces (and internal surfaces for a faulted block). The displacement vectors are solved on the grid nodes. The regularity of the grid makes it very efficient to find which grid cell contains a given point in the concept region and hence calculate the displacement vector at that point by interpolating displacement vectors at nearby grid nodes.

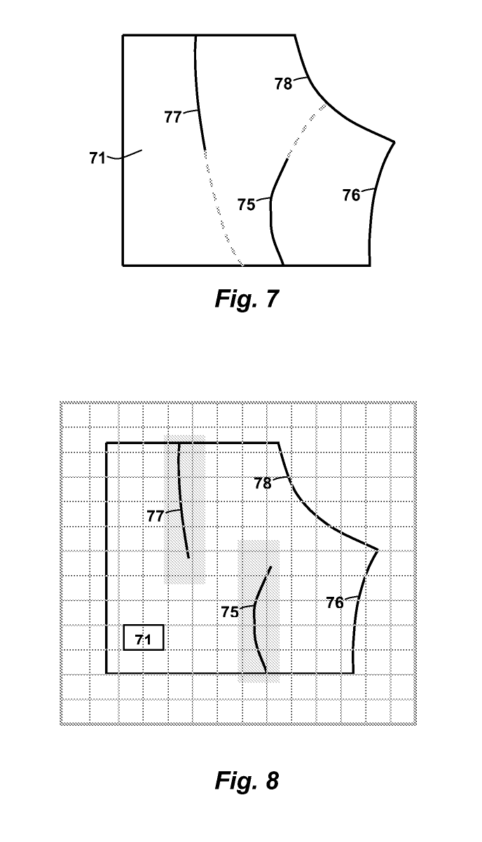

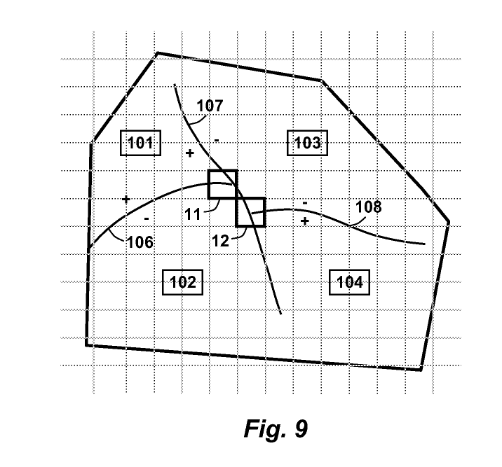

For a faulted block, e.g., Block 71 in FIG. 6A, one can partition the block into simple blocks by extending fault surfaces as shown in FIG. 7, where the solid lines indicate averaged fault traces on the top horizon, and the dashed lines show the extension of fault traces (hence faults) to break the block into three simple sub-blocks. This is a commonly used approach (U.S. Pat. No. 7,480,205B2). The potential drawback is that fault extensions may intersect each other and create many artificial blocks, leading to less efficient calculations and more complicated bookkeeping. An alternative is to solve Eqn. (2) on an overlapping grid without partitioning the faulted blocks. The overlapping grid is logically created by duplicating the cells that intersect with the fault surfaces as well as the nodes attached to the cells. See FIG. 8 for an example, where block 71 in FIG. 6A is embedded in a regular Cartesian grid, and where cells and nodes in the shaded areas are duplicated. These cells/nodes and their duplicates are assigned to the two locally separated areas on the two sides of each fault. FIG. 9 shows another example where the cells/nodes 11 and 12 highlighted in dark lines need to be duplicated so that three copies of the cells/nodes overlap. Each copy is assigned to a local area near the faults. In this case, four local areas 101, 102, 103, and 104 are created by three intersecting faults 106, 107, and 108; they are disjoint near the faults but connected away from fault. Each fault has two sides, labeled by + and − signs and a local area is defined by which side of fault they are on. For example, 101 is defined by faults 106₊ and 107₊, etc. Thus, the three copies of Cell 11 are assigned to 101, 102 and 103, one copy each, and similarly the three copies of Cell 12 are assigned to 102, 103, and 104.

Before solving the equations, one needs to transfer the displacement boundary conditions defined on horizon and fault surfaces to the grid nodes in the vicinity of the surfaces. For a faulted block, discontinuous displacement boundary conditions on two sides of an internal fault surface are extended separately to the overlapping nodes based on the local area the nodes are assigned. For example in FIG. 9, displacement boundary conditions on fault 106₊ and fault 107₊ are extended to nearby nodes assigned to 101. For the highlighted nodes, each will get three sets of boundary conditions.

Extension of the boundary conditions can be done approximately through extrapolation. In one embodiment of the invention, the boundary displacement field is represented by using radial basis functions:

$$u ( x ) = {\sum }_{i = 1}^{N} {w}_{i} φ ( ‖ x - {c}_{i}^{B} ‖ ) , \qquad ( 3 )$$

where φ is a radial basis function, and cᵢ^{B} and wᵢ are, respectively, center points for the radial basis on the bounding surfaces of a block and their associated weights. The weights can be determined through least square fit of u(x) through the boundary displacement field. The displacement vectors on the grid nodes nearby the bounding surfaces can then be evaluated by using Eqn. (3).

In another embodiment of the invention, the extension is achieved by using convolution

$$D ( x ; α ) = {\int }_{B}^{ } w ( y ) \cdot K ( x , y ; α ) d {S}_{y} , \qquad ( 4 )$$

where k is a smooth kernel function parameterized by vector α, w is a vector weight function defined on B, the boundary of block, and integral is a surface integral over B. Again, the weight function can be determined through least square fit of u through the boundary displacement field, or it can be constructed from direct interpolation of the displacement field on the boundary. In general, the kernel function K is a symmetric and positive definite tensor, whose parameters a can be adjusted so that stain in the extrapolated displacement field is minimal. In practice, one may choose an isotropic tensor K=KI to further simplify the calculations.

It may be noted that by using Eqs. (3) or (4), one can calculate a displacement field at any point within a template region. However, this is not recommended, because applying Eqs. (3) and (4) to a large number of points is time consuming and they are not suitable for regions with large boundary displacement. A preferred approach is to use Eqs. (3) and (4) only for extrapolation in the vicinity of the boundary. Near the boundary, the summation and integration can be localized to speed-up the calculations.

Other methods can be used to transfer the displacement boundary conditions. For example, the displacement vector at a grid node nearby a displacement boundary can be obtained by first projecting the node to the boundary. Then, the displacement vector at the projection point on the boundary is obtained and used as an approximation of the displacement vector at the grid node.

An alternative and more rigorous approach to applying the displacement boundary conditions is to use an extended or generalized finite element method (A. Zilian and T.-P. Fries, “A localized mixed-hybrid method for imposing interfacial constraints in the extended finite element method (XFEM),” Int. J. Numer. Meth. Engng, 79, 733-752 (2009)). This method requires calculation of the intersections between the surfaces and the regular grid. Thus, it is more complicated than the extrapolation approach described above. In practice, the approximate method discussed above may be preferred.

It is also possible to solve the linear elasticity equation using a boundary integral method (U.S. Pat. No. 7,480,205 B2) and then calculate the displacement field using the boundary integrals. This method only works when f=0. The method is not so suitable for the present purpose because the boundary integrals are not efficient when u(x) needs to be calculated at a large number of points.

In most applications, λ and μ are constants chosen for each block of a concept region. For large deformation, however, it is useful to keep λ and μ constant in each grid cell but vary from cell to cell. In this case, it is advantageous to let λ=−E and μ=E so that Eqn. (2) admits solid body rotation (R. P. Dwight, “Robust mesh deformation using linear elasticity equations, in H. Deconick and E. Dick (eds.),” Computational Fluid Dynamics 2006, 401-406). If E is a constant independent of x, then Eqn. (2) simplifies to

Δu=f/E,

a second order Poisson equation. This equation can be more efficiently solved by solving each component of u separately.

Create Conceptual Model in Design Region

The next step is to create conceptual interfaces and properties within the design regions (see Create Geologic GCMs).

In practice, the controlling parameters of the functions, such as their skeletons, may be first inserted into the design space. Many ways can be used to create the skeletons. An example is a sketch interface in which the user is provided a drawing tool to sketch the skeletons on computer screen using freeform line or curve drawing.

Another example is a set of predefined skeleton primitives that can be directly placed into the design space. The primitives are designed based on geologic concepts and depositional models associated with the concepts. They are often part of a GCM for a geologic concept. The primitives can be created using the freeform drawing tool and stored digitally in files, so that they can be reused for future modeling work. They can also be created based on a conceptual depositional model automatically. The automatic method helps to ensure the conceptual regions and interfaces are compatible with the bounding surfaces of the design region as well as measured data associated with the design region.

Once skeleton primitives are positioned in the design region, the associated generator functions for interfaces and properties can be evaluated everywhere in the design region. In one embodiment, the generator functions are defined in the local coordinate system associated with the skeleton primitives. The skeleton primitives will, in general, induce one or more local curvilinear coordinate systems in the design region. One way to form a coordinate system based on skeleton primitives is by using approximate level set functions based on skeleton primitives, i.e. skeleton is approximated by a certain level set of a coordinate function. For example, distance fields from three intersecting skeleton surfaces in 3D can be used as coordinate functions.

Another method for creating conceptual interfaces is to use a skeleton in the form of a reference surface created from a series of user input polylines. This reference surface is linked to the top and base interfaces and defines a stratigraphic pattern in which the conceptual interfaces should be created. There are multiple ways of creating this surface (FIG. 16). In addition to top and base interfaces, and the reference surface, well data if present should be provided to control the location of the conceptual interfaces. The reference surface links together polylines from both conceptual and explicit interfaces and thus provides a way of defining conceptual interfaces from the explicit ones. For that purpose, an elliptic partial differential equation (such as Laplace equation) for a displacement vector field is solved for each conceptual interface. The boundary conditions for the partial differential equation are derived from the reference surface and wells. The solution displacement field is applied to the explicit interfaces in order to obtain the corresponding conceptual interface.

In order to assign a property on every point on the interface, any of the following methods can be used, among others:

1. Build an explicit surface representation, e.g. a triangulated surface, and assign property values on the nodes of the surface elements. Values inside the surface elements can be obtained by appropriate interpolation of nodal values.
2. Build a parameterized surface representation and then assign properties in the parameter space (U.S. Pat. No. 6,300,958, U.S. Pat. No. 6,820,043). The parameterization, in particular, could be based on the skeleton of the GCM and 1D and/or 2D trends of the property values.
3. Define a volume property on a volume that contains the interface and then evaluate the restriction of the property on the interface.
All of the above methods allow computation of surface integrals on an interface.

Since conceptual regions may be nested hierarchically, the conceptual model is built in a hierarchical manner, starting with the largest features and proceeding to fill finer levels within the already constructed parent levels. Each finer level is volumetrically confined within its parent, and its generator functions need to be evaluated only inside its parent and not in the entire design region, unless otherwise designated. Thus, evaluation of generator functions in a conceptual model is done following the GCM hierarchy structure from the largest level down to finer levels.

Condition Conceptual Model in Design Space

One of the biggest advantages of functional representations of the interfaces and regions is conditioning to data. Typically, two types of data need to be conditioned: 1) volumetric trend data as interpreted from seismic imaging and 2) surface picks, reservoir properties and geologic interpretation at wells. The volume trend should be consistent with observation at wells. In particular, rock properties in the intervals between surface picks along the wells should be consistent with the volumetric trend. Otherwise, data preferably need to be re-interpreted until consistency is achieved.

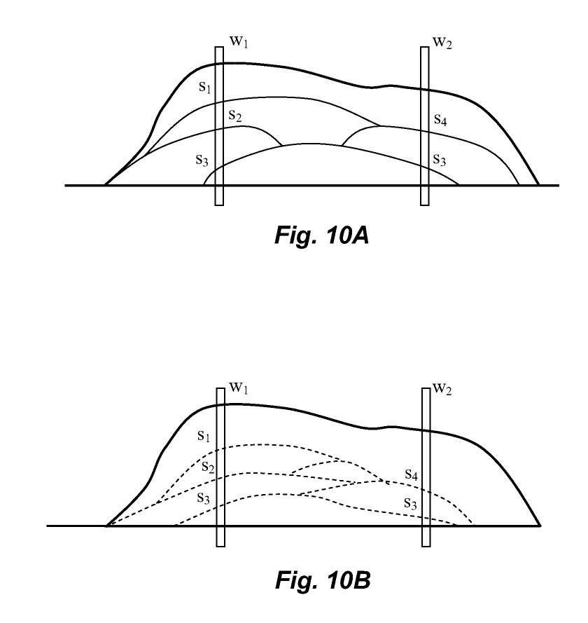

The conditioning starts with hierarchically matching interfaces (starting with major interfaces and then proceeding with their dependents) with corresponding wells picks, because interfaces often control the property distribution as discussed above. FIG. 10A shows an example of well picks (two wells, w₁ and w₂) for a geologic scenario and FIG. 10B shows a compatible realization. Typically, a realization is said to be compatible if the number of well-surface intersections (well picks), their order along each well track, and inter-well associations of the picks are the same as those interpreted from the well data. Further constraints, such as the age of the conceptual regions between two well picks, can be added. In FIG. 10A, if the interval between s₂ and s₃ is deemed older than the interval between s₄ and s₃, then the realization on the right is not compatible with this constraint.

Conditioning to well tops consists of two steps. First, a compatible realization is generated for a given set of well picks. Then, the realization is adjusted to make the surfaces match well picks precisely. While the first step is the key step, the simpler, second step is described first.

The second step can be done by adjusting the parameters of the generators and/or the parameters of the selection function. Different selection functions can also be used to change the boundaries between the conceptual regions. The adjustments can be done manually, or automatically through an optimization procedure. Let sᵢ (i=1, . . . , M) be the well picks in terms of measured depth along the wells. Similarly, let sᵢ^{d} (i=1, . . . , M) be the well picks for a compatible realization. The optimization is to minimize the difference between the two sets, e.g., Σᵢ₌₁^{M}(sᵢ^{d}−sᵢ)². Other norms can be used to measure the difference. For example, one can minimize the difference along each well and perform a multi-objective optimization. It should be noted that sᵢ^{d} can be easily calculated along each well track by using the region generators as well as the selection function. In fact, no evaluation away from the wells would be needed. This makes the calculation of sᵢ^{d} very efficient. Furthermore, adjusting parameters of the functions induces smooth global changes—and sometimes changes in region topology—which is difficult to achieve or manage using cell-based techniques.

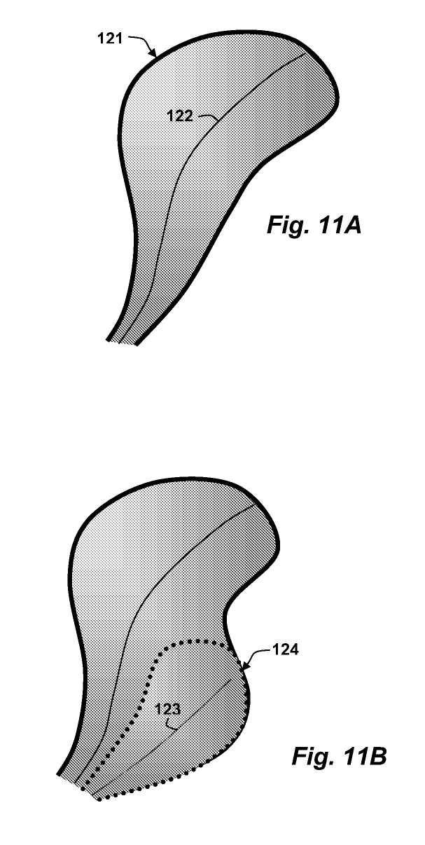

Another way to adjust the generator functions is to change their parameterization. This can be easily done for generators parameterized with skeletons. For example, adding a line segment to an existing skeleton can change the shape of the generated region. FIGS. 11A-B show an example. FIG. 11A shows the original shape of the conceptual region 121 determined by a curvilinear skeleton 122. Adding another curvilinear line or segment 123 to the skeleton changes the shape of the conceptual region 124 in FIGS. 11B and D. This technique is useful for adding or adjusting a local feature without disturbing the region globally. For convolution functions, the added skeletal element can be smoothly merged into the existing one (J. Bloomenthal and K. Shoemake, “Convolution Surfaces,” Proc ACM SIGGRAPH 25, 251-257 (1991)). For generators defined with the help of displacement vector fields, well data can be incorporated as the additional boundary conditions for calculation of displacements.

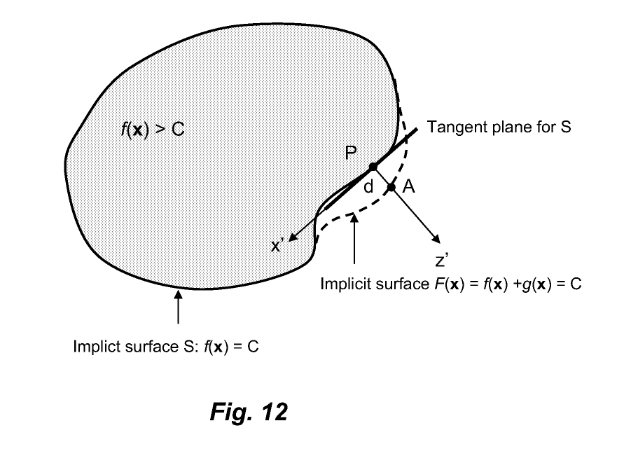

The above two approaches may often be combined into a two-step process. First, the global optimization is applied by adjusting the parameters of the generators. Then, the generators can be enriched by adding local functions with additional parameters. For example, a well-known method to enrich an explicit surface function of the form z=ƒ(x, y) is using two-dimensional radial basis functions φ(∥x₂−c₂∥) where the subscript 2 indicates two-dimensional vectors in the x-y plane. For surfaces defined through implicit functions, similar enrichment can be achieved by using local coordinates on the surface. An example is shown in FIG. 12, where an implicit function ƒ(x) is enriched so that the iso-surface of the new function F(x) passes through point A. As shown in the drawing, the tangent plane at the projection P of A on the implicit surface is used to setup the local coordinates. The local feature is captured by a function g(x) such that g(x_{A})=1 and its value decrease as ∥x−x_{P}∥ increases. Let

F(x)=ƒ(x)+[C−ƒ(x_{A})]g(x),

with the result F(x_{A})=C. An example of g(x) is

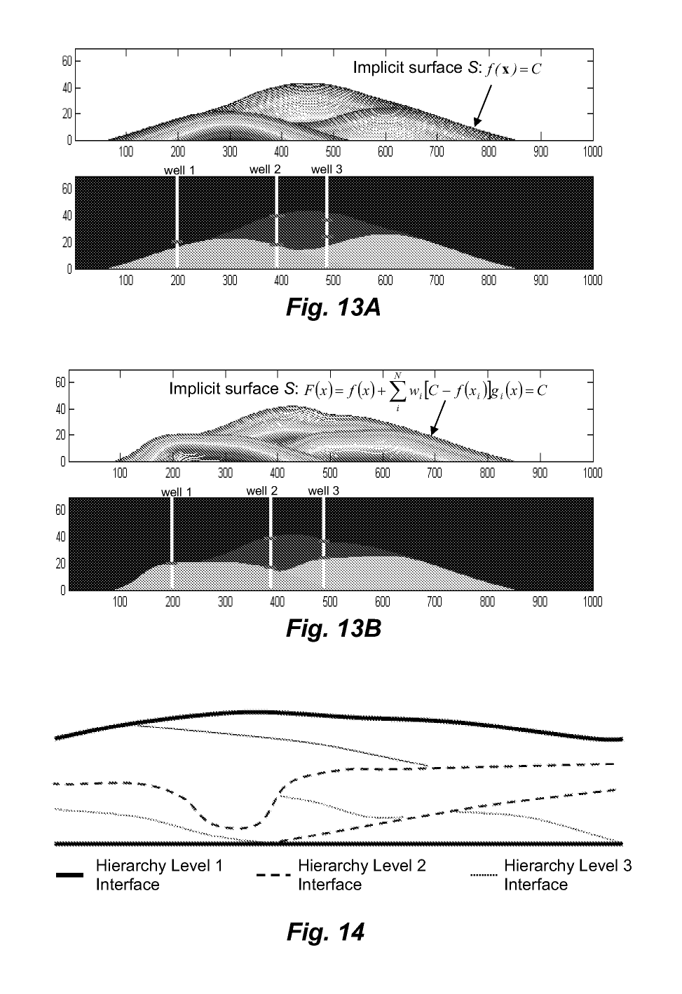

g(x)=exp[(d²−∥x−x_{P}∥²)/R²],

where d is the distance between A and P (see FIG. 12), and R is used to control the radius of influence of g. Other functions can be used. When the implicit surface needs to be adjusted at multiple points, say xᵢ (i=1, . . . , N), one can use a function gᵢ for each point and the enriched function can be written as

$$F ( x ) = f ( x ) = {\sum }_{i = 1}^{N} {w}_{i} [ C - f ( {x}_{i} ) ] {g}_{i} ( x ) ,$$

where wᵢ are weights that can be solved from the conditions F(xᵢ)=C for each i. An example of applying this technique is shown in FIGS. 13A-B. FIG. 13A shows at the top: contour lines of three generator functions; at the bottom: conceptual regions partitioned using selection functions. The conceptual interfaces are not matching well picks at well 1 and well 3. FIG. 13B shows at the top: contour lines of enriched generator functions; bottom: conceptual interfaces match well picks. Conceptual interfaces are matching well picks at well 1, well 2 and well 3 after local enrichment.

There are many ways to generate the initial compatible realization. For a small number of well picks, this can be done manually through an interactive user interface. Given a set of well picks, there are potentially infinitely many compatible realizations. Further, geologic constraints should be used to focus on realistic scenarios. For example, when modeling deep water fan environment, the hierarchical branching network formed by active or abandoned channels can be used to constrain the locations of various conceptual regions at different stratigraphic hierarchical scales. The branching network may be generated first based on a conceived geologic scenario, or interpretation from seismic data and well picks. Different types of constraints may be used for different geologic environments, which will be understood by practitioners in the technical field.

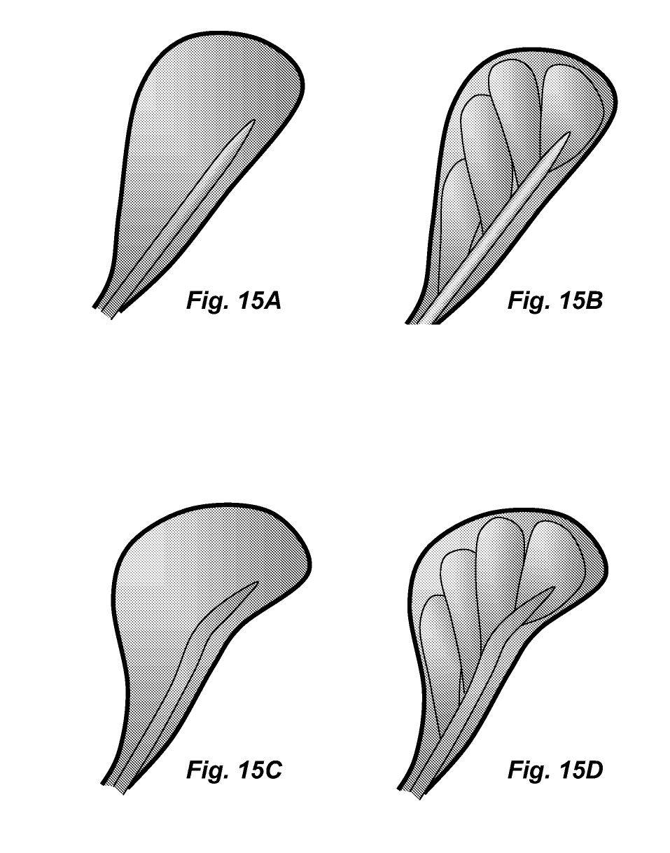

When there are more than a few well picks, manually creating a compatible realization can be tedious and error prone. One way to ease the process is to use hierarchical modeling as described above, taking advantage of the fact that geologic interpretations are usually hierarchical based on the scales of geologic events. Sequence Stratigraphy, which is widely used in practice, is an excellent example. FIG. 14 shows a hierarchical interpretation of a deepwater channel-lobe system. The interfaces and hence their trace at the wells may be identified as (part of) the boundaries of hierarchy level 1, hierarchy level 2, hierarchy level 3, etc. features, from large to small scales, with the larger scale regions containing several smaller scale regions. Thus, a hierarchical interpretation of a channel system leads to hierarchical grouping of well picks.

Therefore, conditioning can be done one hierarchy level at a time from large to small scales, starting from the lowest level or largest scale in the hierarchy. A compatible realization can be generated taking into account only the well picks corresponding to that hierarchy level. Information needed to be taken into account is greatly reduced, with is helpful to either a manual or an automated process. After conditioning a lower-level conceptual interfaces and hence regions, one can move on to the next higher level of the hierarchy and repeat the process within each of the lower-level conceptual region independently. The recursive process stops when all necessary levels in the hierarchy are conditioned. Again, parallel processing can be naturally applied to this computer-implemented process to obtain further speed-up, especially at higher levels.

Once the interfaces are conditioned, property generators can be adjusted to reflect the property trend within the conceptual regions. This is relatively straightforward since the interpretation at the wells should be consistent with the property trends.

In many applications, it is desirable to generate multiple realizations of the same GCMs. A typical example is an uncertainty study of reservoir performance and history matching with multiple reservoir models. These applications require a more automated method to generate different compatible realizations given a set of well picks and related seismic trends.

Stochastic modeling with GCMs can be achieved through the use of stochastic parameterization of conceptual region and property generators. The parameterization depends on the geologic setting and needs to be developed accordingly. Once the parameterization is available, stochastic realizations can be generated by drawing random parameter values from their prescribed probability distributions. Unlike traditional geo-statistics, non-stationary and highly correlated but minority features can be adequately represented because they are already taken into account in the realization of the GCM.

Map Conceptual Model to Concept Region

After conditioning is done, the resulting conceptual regions need to be mapped from design region to the original concept region. One possible embodiment of the invention involves mapping from the design region into the concept region only a small number of control points that define the skeleton of a GCM. The mapping procedure has been discussed above. Since the skeleton of a GCM is essentially a local curvilinear coordinate system, every geometric shape or property defined with respect to the skeleton will be mapped accordingly. Since the GCMs are nested hierarchically, the position of the control points of a parent GCM determines automatically the mappings for the child GCMs. Once the skeleton of a GCM is mapped, the GCM can be generated directly in the concept region without further mapping. FIGS. 15A-D show an automatic nested mapping of GCM into the concept region. FIG. 15A shows a large scale parent conceptual region in the design space. Several smaller scale child regions are defined within the larger region in FIG. 15B. When the larger (parent) region is mapped to the concept region through the mapping of its skeleton in FIG. 15C, the child regions are mapped automatically based on their relationship with the parent region (FIG. 15D). The mapping does not need to be very accurate; therefore, it may be preferable to apply additional conditioning in the concept region.

Another embodiment of the invention involves direct sampling of the GCM from the design region into the concept region. Each sample point in the concept region is first mapped into the design region based on the displacement field calculated during the generation of the design region. The generators and selection function are evaluated at the mapped point to determine which conceptual region contains it. Then, functions representing property distributions are evaluated at the mapped point. The property values are assigned to the corresponding sample point in the concept region. Through this method, all relevant information contained in the GCM can be sampled at all points of the concept region. In practice, it is seldom necessary to sample every point of the concept region, instead sampling a discrete set of points sufficient for either visualization or simulation purposes. In the case of visualization, the sampling may be performed on a regular voxel grid based on screen resolution and viewing angle; or the sampling may be determined by ray tracing algorithms for volume rendering. In the case of simulation, typically a simulation grid is generated in the concept region first. Property values are then sampled onto the simulation grid. Thus, in this approach, the concept regions and hence the geologic model is defined through sampling of the design space.

The foregoing patent application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

What is claimed is:

1. A computer implemented method for constructing a geologic model of a subsurface volume comprising:
selecting a geological structural framework for the subsurface volume; and
using a computer to generate values of one or more physical properties for one or more regions within the geological structural framework using a conceptual model based on geologic concepts, said conceptual model comprising the one or more concept regions with one or more interfaces, wherein the interfaces are expressed in implicit functional form and the concept regions are expressed in explicit or implicit functional forms.

2. The method of claim 1, wherein the one or more physical properties are also expressed in implicit or explicit functional form.

3. The method of claim 2, wherein the geologic concepts and the physical properties are expressed exclusively in explicit or implicit functional form, i.e. without use of a geo-cellular grid.

4. The method of claim 1, wherein the geologic concepts affect movement of fluids in the subsurface volume.

5. The method of claim 1, wherein the geologic concepts are represented at least partly by one or more conceptual surfaces and by the concept regions, which are defined by the one or more conceptual surfaces.

6. The method of claim 5, wherein the one or more physical properties are represented, within a concept region or on a conceptual surface, using mathematical functions.

7. The method of claim 6, wherein the mathematical functions are parameterized relative to reference surfaces, lines, or points.

8. The method of claim 1, wherein the one or more physical properties comprise at least one of a scalar porosity and a tensor permeability.

9. The method of claim 2, wherein the geological structural framework contains at least one concept region defined by one or more faults or other conceptual surfaces.

10. The method of claim 9, further comprising:
selecting a concept region from within the subsurface volume, and a geologic concept for the concept region;
mapping the concept region and associated geophysical data to a design region defined by a selected mathematical mapping;
generating the conceptual model based on the selected geologic concept; and
mapping the conceptual model from the design region back into the concept region, it becoming the geologic model for the concept region.

11. The method of claim 10, further comprising mapping geophysical data associated with the concept region to the design region, and conditioning, i.e. adjusting, the conceptual model so that region interfaces and the one or more physical properties are consistent with the geophysical data.

12. The method of claim 11, wherein the geophysical data comprise at least one of well log data and seismic attribute data.

13. The method of claim 10, wherein the mapping may be at least partly 1:1.

14. The method of claim 10, wherein generating the conceptual model comprises selecting a model from a catalog of pre-built and re-usable generic concept models saved in computer storage.

15. The method of claim 14, wherein the generic concept models are based on skeleton primitives that are designed based on the geologic concepts and on depositional models associated with the geologic concepts.

16. The method of claim 15, wherein the explicit and implicit functional forms are parameterized, and the catalog of pre-built and re-usable generic concept models saved in computer storage are generated, at least in part, by varying the parameters to generate different realizations of a single generic concept model.

17. The method of claim 10, wherein the concept region is faulted or continuous but the design region is continuous.

18. The method of claim 10, wherein the mapping between the design region and a faulted concept region is performed using a vector displacement field calculated by solving linear elasticity equations and variations with displacement boundary conditions on restored horizons and faults in the design region.

19. The method of claim 18, wherein displacements in the displacement field pertain to one or more faults in the concept region and blocks within the concept region defined by the faults, and the solution of the linear elasticity equations is obtained on grid nodes of a regular grid covering each block using immersed boundary methods.

20. The method of claim 19, wherein the displacement vectors on the grid nodes are interpolated to give the mapping.

21. The method of claim 11, wherein the conditioning is performed in a hierarchical manner where children elements of a concept region are conditioned to a conceptual or interpreted parent element.

22. The method of claim 21, wherein for one level of hierarchy, first the conceptual surfaces are conditioned to well picks by adjusting parameters of implicit or explicit functions that represent the conceptual surfaces, then adjusting parameters of functions that represent the physical properties in the concept regions so that the physical properties honor trends observed from the seismic attribute data or honor estimated values in the well log data.

23. The method of claim 16, wherein the generic concept models are designed and the functional forms are developed through steps comprising:
(a) sketching a generic concept model using the skeleton primitives;
(b) choosing region and property generators and selection functions;
(c) rendering the generic concept model;
(d) repeating (b)-(d) if quality of the rendered concept model satisfy a predetermined standard;
(e) selecting variable parameters for the generic concept model's functional form;
(f) rendering multiple realizations of the generic concept model by varying values of the variable parameters within ranges;
(g) repeating (e)-(g) until quality of the rendered realizations satisfy a predetermined standard; and
(h) saving the skeleton primitives, property generators, selection functions, and the ranges of values of the variable parameters in computer storage.

24. A method for producing hydrocarbons from a subsurface region, comprising:
developing a geologic model of the subsurface region using a method of claim 1;
and either
using the geologic model to assess hydrocarbon potential of the subsurface region,
and drilling a well into the subsurface region based at least partly on the assessment of hydrocarbon potential, and producing hydrocarbons from the well; or
using the geologic model to manage production of hydrocarbons from an existing well or wells into the subsurface region.

25. A computer readable program product, comprising a non-transitory computer usable medium having a computer readable program code embodied therein, said computer readable program code adapted to be executed to implement a method for constructing a geologic model of a subsurface volume, said method comprising:
selecting or inputting a geological structural framework for the subsurface region; and
generating values of one or more physical properties for regions within the geological structural framework using a conceptual model based on geologic concepts expressed in implicit or explicit functional form, with at least one geologic concept expressed in implicit functional form.

26. The computer readable program product of claim 25, wherein the generating values comprises:
defining at least two concept regions in the geological structural framework based on one or more faults or other conceptual surfaces;
selecting a concept region from within the geological structural framework, and a geologic concept for the concept region;
mapping the concept region and associated geophysical data to a design region defined by a selected mathematical mapping;
generating the conceptual model based on the selected geologic concept; and
mapping the conceptual model from the design region back into the concept region, it becoming the geologic model for the concept region.
